(19) United States
(12) Patent Application Publication
(10) Pub. No.: US 2026/0192591 A1
(43) Pub. Date: Jul. 9, 2026

(54) CORE FOR WRITING, DRAWING AND/OR PAINTING IMPLEMENTS AND METHODS FOR THE PRODUCTION THEREOF

(71) Applicant: STAEDTLER SE, Nürnberg (DE)

(72) Inventor: Martin JAKOB, Hallstadt (DE)

(21) Appl. No.: 19/432,694

(22) Filed: Dec. 24, 2025

Related U.S. Application Data
(63) Continuation of application No. 17/635,460, filed on Aug. 20, 2020.

(30) Foreign Application Priority Data
Aug. 27, 2019 (DE) 10 2019 006 035.0

(51) Int. Cl. B43K 19/18; B43K 19/02; C08L 1/28

(52) U.S. Cl. CPC B43K 19/18; B43K 19/02; C08L 1/284

(57) ABSTRACT

A core for writing, drawing and/or painting implements, including at least one binder, at least one wax, and at least one filler. The core is in the form of a graphite lead. Wherein the at least one binder is hyroxypropyl cellulose and the content of the at least one binder is 7 to 45 wt. %.

### CROSS-REFERENCE TO RELATED APPLICATIONS

The present application is a Continuation of U.S. patent application Ser. No. 17/635,460, filed Feb. 15, 2022, which is a 371 of International application PCT/EP 2020/025382, filed Aug. 20, 2020, which claims priority of DE 10 2019 006 035.0, filed Aug. 27, 2019, the priority of these applications is hereby claimed and these applications are incorporated herein by reference.

### BACKGROUND OF THE INVENTION

The invention relates to cores for writing, drawing and/or painting implements based on thermoplastic binders, and a method for the production thereof.

Cores based on thermoplastic binders for drawing, writing and/or painting are known in principle.

DE 102008034014 A 1 discloses a core which contains at least thermoplastic binders, wax and fillers. The binder used is polystyrene, styrene-acrylonitrile, styrene-budadiene, polyolefins and acrylonitrile-budadiene-styrene.

It is to be seen as disadvantageous here that cores designed in this way are not designed so that they are water-soluble/water-colorable and are built up on petroleum-based raw materials.

Furthermore, cores are known from the prior art which are constructed and produced on the basis of cellulose derivatives, wherein these derivatives are used as binders. In a first step, raw cores are pressed with the addition of water. In a second step, these raw cores have to be dried in order to obtain a ready-to-use core.

Examples of this would be cores according to DE 4214396 A 1 and EP 0836846B1.

It is to be regarded as disadvantageous here that a plurality of work steps is required in order to arrive at a ready-to-use core. The solvent/water is subsequently removed by drying with great energy consumption and the cores are finally impregnated with wax, grease and/or oil.

It is also to be regarded as disadvantageous that, due to a lack of thermal stability, most cellulose derivatives cannot be exposed to elevated temperatures and thus cannot be thermoplastically deformed or processed.

Therefore, manufacturing processes that require high temperatures, for example, greater than 130° C., cannot be used.

In addition, it is to be regarded as disadvantageous that, in addition to the swelling phase of the celluloses, drying, an additional impregnation is required for the production of cores which are water-colorable.

### SUMMARY AND DESCRIPTION OF THE INVENTION

The object of the invention is therefore to create a core for writing, drawing and/or painting that does not have the disadvantages mentioned. The object is to create a core, designed as a graphite and/or colored core, which is built up on the basis of cellulose and, in particular, can be processed or produced thermoplastically and which is designed to be water-soluble/water-colorable. A further object of the invention is to produce a core inexpensively with as little effort as possible, particularly with few work steps.

This object was achieved by creating a core composition which has hydroxypropyl cellulose (HPC) as a binder. It has also been shown in a surprising manner that cores built-up in this way can be produced in one work step and are also designed to be water-colorable.

A core was created for writing, drawing and/or painting implements, at least comprising at least one binder, at least one wax, at least one coloring substance and at least one filler, wherein the core is in the form of a lead core and/or colored core, wherein the at least one binder is hydroxypropyl cellulose (HPC) and wherein the hydroxypropyl cellulose content is 7 to 45 weight %.

The proportion of the at least one binder in the form of HPC in the core composition is in the range of 7 to 45 weight %, preferably in a range of 10 to 35 weight %. A particularly preferred range of added binder in the form of HPC is 16 to 28 weight %.

HPC is a derivative of cellulose and is soluble in both water and organic solvents. HPC is thermoplastic.

To date, HPC has been used as a pharmaceutical excipient, as a binder for ceramic masses, coatings for adhesives, in cosmetic articles, in printing inks and in polymerization technology.

It has been shown in a surprising way that HPC can be used in cores without losing the original user requirements of a core. These requirements are breaking strength per se, stability during the sharpening process, erasability of the smear and the ability to slide.

It has also been found that cores produced in this way are designed to be water-soluble and water-colorable.

These surprising effects were found with lead cores and colored cores.

The following frame examples and recipe examples are mentioned in order to show a core designed in this way more precisely.

It has been found to be beneficial when the core has
7 to 45 weight % HPC (binder 1)
5 to 65 weight % fillers
0.5 to 15 weight % coloring substance (pigment)
0 to 30 weight % binder 2
0 to 30 weight % wax and/or oils
0 to 15 weight % surfactant.

In particular, it is preferred when the core has
10 to 35 weight % HPC (binder)
9 to 50 weight % fillers
1.5 to 14 weight % coloring substance (pigment)
0 to 30 weight % binder 2
0 to 30 weight % wax and/or oils
0 to 10 weight % surfactant.

The at least one filler is advantageously a mineral filler. Fillers from the groups comprising graphite, hexagonal boron nitride, kaolin, sheet silicates, talc, chalk, barite, colored pigments and/or achromatic pigments may be mentioned as examples.

Graphite or graphite in combination with carbon black is preferred as a filler or as a coloring filler for lead cores.

For colored cores, combinations of white or colorless fillers, such as hexagonal boron nitride, phyllosilicates, etc., with coloring pigments, such as azo pigments, phthalocyanines, dioxazines, quinacridones, iron oxides, carbon black, graphite, ultramarine, iron-cyan complexes have proven successful.

Binder 2, polyvinyl alcohol, polyethylene glycol and/or polyvinyl butyral may be mentioned by way of example as a further binder.

A composition for a water-soluble lead core comprises:
7 to 40 weight % HPC (binder 1)
5 to 70 weight % fillers
0 to 20 weight % coloring substance (pigment)
0 to 30 weight % binder 2
0 to 3 weight % wax and/or oils
0.5 to 15 weight % surfactant.

Example recipe for a lead core comprises:
20 weight % HPC (binder 1)
61 weight % talc
9 weight % polyethylene glycol (binder 2)
7 weight % graphite
1.5 weight % oxidized PE wax
1.5 weight % EO/PO block copolymer.

As shown in the example, graphite is used as the coloring substance for lead cores. However, a combination of graphite and carbon black can also be used.

A composition for a colored pencil core comprises:
7 to 45 weight % HPC (binder 1)
5 to 65 weight % fillers
0.5 to 15 weight % coloring substance (pigment)
0 to 28 weight % binder 2
0 to 30 weight % wax and/or oils
0 to 15 weight % surfactant.

Example recipe for a colored pencil core:
23 weight % HPC (binder 1)
56 weight % chalk
7 weight % quinacridones
14 weight % amide wax.

Colored and/or achromatic pigments can be used as coloring agents for colored cores. Examples of such pigments would be azo pigments, phthalocyanines, dioxazines, quinacridones, iron oxides, carbon black, graphite, ultramarine and iron-cyan complexes.

At least one wax from the group comprising fatty acids, stearates, montan waxes, amide waxes and paraffins can be used as the at least one wax.

The oils used can be in the form of palm oil, palm kernel oil and/or soybean oil, for example.

Surfactants can be EO/PO block polymers, ethoxylated alcohols and/or alkyl polyglycosides.

The extrusion method has proven itself as a method for producing a core according to the invention.

The core according to the invention is produced particularly by performing the following steps:
mixing and granulating all recipe components of the core to a core granulate
extruding the core granules at a temperature in the range of 100 to 180° C. in an extruder through a suitable mouthpiece to form endless core strands
cooling and solidifying the endless core strands, and
cutting the endless core strand to a given length, particularly to the required pencil length

Depending on the extrusion head, the core cross-section can take any shape-round, angular or combinations thereof. Furthermore, there is also the option to combine different core recipes in one extrusion head to form a multi-component core via multiple coextrusion.

In addition, the core granulate can be extruded into a complete lead by means of suitable coextrusion processes with other polymer-bound materials.

1. A core for writing, drawing and/or painting implements, comprising: at least one binder; at least one wax; and at least one filler, wherein the core is a graphite lead, wherein the at least one binder is hydroxypropyl cellulose (HPC) and wherein the content of hydroxypropyl cellulose is 7 to 45 weight %.

2. The core according to claim 1, wherein the content of hydroxypropyl cellulose is 10 to 35 weight %.

3. The core according to claim 1, wherein the core comprises
7 to 45 weight % HPC (binder 1)
5 to 65 weight % fillers
0.5 to 15 weight % coloring substance(pigment)
0 to 30 weight % binder 2
0 to 30 weight % wax and/or oils
0 to 15 weight % surfactant.

4. The core according to claim 1, wherein the core contains
10 to 35 weight % HPC (binder)
9 to 50 weight % fillers
1.5 to 14 weight % coloring substance (pigment)
0 to 30 weight % binder 2
0 to 30 weight % wax and/or oils
0 to 10 weight % surfactant.

5. The core according to claim 1, wherein the filler includes graphite.

6. The core according to claim 3, wherein the coloring substance includes graphite.

7. A method for producing a polymer-bound core according to claim 1, comprising forming the core by extrusion.

8. A method for producing a polymer-bound core according to claim 7, comprising the steps of:
mixing and granulating all components of the core to a core granulate;
extruding the core granules at a temperature in a range of 100 to 180° C. in an extruder through a mouthpiece to form endless core strands;
cooling and solidifying the endless core strands; and
cutting the endless core strands to a given length.
